(19) United States
(12) Patent Application Publication
(10) Pub. No.: US 2026/0179157 A1
(43) Pub. Date: Jun. 25, 2026

(54) POWER INFORMATION MANAGEMENT METHOD, POWER INFORMATION MANAGEMENT SYSTEM, CONTRACT METHOD, CONTRACT SYSTEM, VERIFICATION METHOD, AND VERIFICATION SYSTEM

(71) Applicant: Panasonic Intellectual Property Management Co., Ltd., Osaka (JP)

(72) Inventor: JUN HIRANO, Osaka (JP)

(21) Appl. No.: 19/541,216

(22) Filed: Feb. 16, 2026

Related U.S. Application Data
(63) Continuation of application No. PCT/JP2025/015681, filed on Apr. 23, 2025.

(30) Foreign Application Priority Data
May 15, 2024 (JP) 2024-079261

(51) Int. Cl. G06Q 50/06

(52) U.S. Cl. CPC G06Q 50/06

(57) ABSTRACT

A power information management method includes keeping a record indicating that a power consumer under an actual-demand contract with a power supplier has responded to a request to increase an amount of power consumption in a predetermined period, and transmitting the record to the power supplier.

### BACKGROUND

### 1. Technical Field

The present disclosure relates to a power information management method, a power information management system, a contract method, a contract system, a verification method, and a verification system.

### 2. Description of the Related Art

Demand control of power is being examined. Japanese Unexamined Patent Application Publication No. 2009-240054 describes an example of the demand control.

### SUMMARY

One non-limiting and exemplary embodiment provides techniques for making it possible to take a reasonable measure when a power consumer under an actual-demand contract increases the amount of power consumption on the basis of a request to increase the amount of power consumption.

In one general aspect, the techniques disclosed here feature a power information management method including keeping a record indicating that a power consumer under an actual-demand contract with a power supplier has responded to a request to increase the amount of power consumption in a predetermined period, and transmitting the record to the power supplier.

With the techniques according to the present disclosure, a reasonable measure can be taken when a power consumer under an actual-demand contract increases the amount of power consumption on the basis of a request to increase the amount of power consumption.

It should be noted that general or specific embodiments may be implemented as a system, a method, an integrated circuit, a computer program, a storage medium, or any selective combination thereof.

Additional benefits and advantages of the disclosed embodiments will become apparent from the specification and drawings. The benefits and/or advantages may be individually obtained by the various embodiments and features of the specification and drawings, which need not all be provided in order to obtain one or more of such benefits and/or advantages.

### BRIEF DESCRIPTION OF THE DRAWINGS

FIG. 1 is a configuration diagram of an infrastructure according to an embodiment;

FIG. 2 is a sequence diagram illustrating an example of a scenario that can occur in the infrastructure;

FIG. 3 is a flowchart illustrating determination of contract demand;

FIG. 4 is a sequence diagram illustrating a modification of the example of the scenario that can occur in the infrastructure; and

FIG. 5 is a flowchart illustrating issuance of an electronic certificate according to the modification.

### DETAILED DESCRIPTIONS

### Underlying Knowledge Forming Basis of Present Disclosure Etc.

An actual-demand contract may be concluded between a power supplier and a power consumer. In an actual-demand contract, larger contract demand is set between a power supplier and a power consumer as a maximum demand value of the power consumer increases. The maximum demand value is a maximum value of a demand value in the most recent period. The demand value is average power consumed in each unit period. The contract demand is determined on the basis of the maximum demand value.

If a demand value of even one unit period exceeds a maximum demand value in the most recent period, the maximum demand value is updated, and larger contract demand is set. When the larger contract demand is set, a higher electricity charge is imposed over a specified period beginning with the time of the setting. Some power consumers, therefore, introduce an energy management system (EMS) configured to suppress an increase in a demand value in each unit period.

Surplus power, on the other hand, can be caused in a power system as a result of an increase in power generated using renewable energy according to natural conditions, such as an increase in generated power of solar power generation in sunny conditions. A power consumer can consume the surplus power through an upward demand response (DR) to stabilize the power system.

As can be understood from the above description, the EMS can suppress an increase in the demand value. The upward DR, on the other hand, can increase the demand value. The EMS and the DR can thus be incompatible with each other.

Specifically, an event can occur where the EMS operates in such a way as to prevent an increase in the demand value and a power consumer cannot respond to an upward DR. If the power consumer responds to an upward DR by invalidating the EMS, on the other hand, the demand value increases, and an electricity charge can accordingly increase. An increase in the electricity charge can become apparent when the power consumer responds to an upward DR while equipment of the power consumer is under a high load.

The present inventor, therefore, has examined techniques for making it possible to take a reasonable measure when a power consumer under an actual-demand contract increases the amount of power consumption on the basis of an upward DR.

An embodiment of the present disclosure will be described hereinafter with reference to the drawings. The present disclosure is not limited to the following embodiment.

In the description of the embodiment, “the amount of power consumption” is a time integral of “power consumption”, and a unit thereof is Wh.

### Embodiment

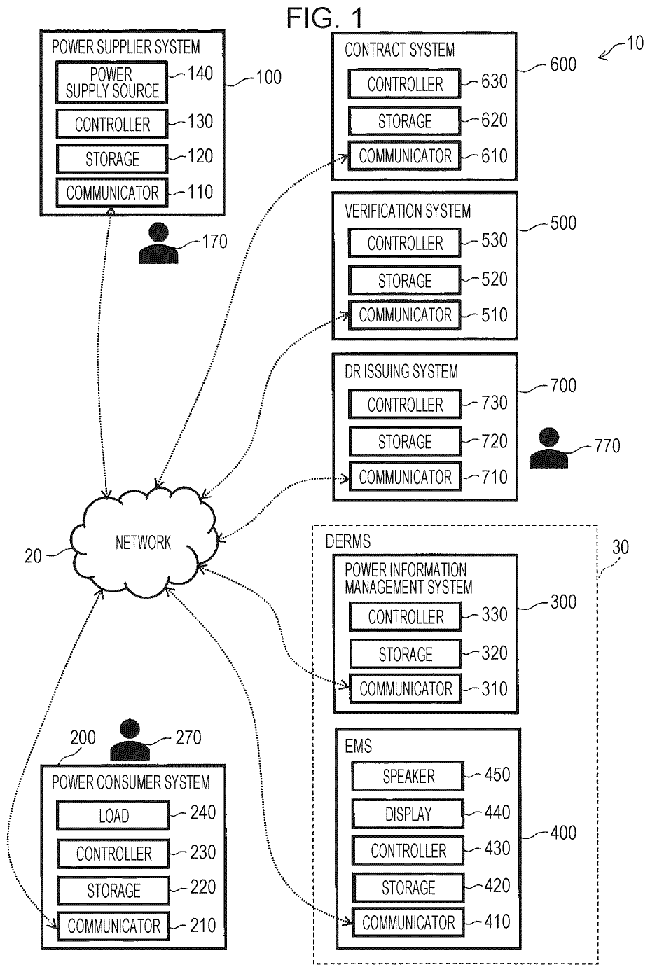

The embodiment will be described hereinafter with reference to FIGS. 1 to 3.

### Configuration of Infrastructure 10

### Outline of Configuration of Infrastructure 10

FIG. 1 is a configuration diagram of an infrastructure 10 according to the embodiment.

In the infrastructure 10, a power supplier system 100, a power consumer system 200, a power information management system 300, an EMS 400, a verification system 500, a contract system 600, and a DR issuing system 700 are connected to each other via a network 20 and communicate with each other via the network 20. A distributed energy resource management system (DERMS) 30 including the power information management system 300 and the EMS 400 is constructed.

The components of the infrastructure 10 will be described in detail hereinafter.

### Power Supplier System 100

The power supplier system 100 is for a power supplier 170. The power supplier 170 may be a natural person or may be a juridical person. The power supplier 170 may be a power generation operator or may be a power retailer.

The power supplier system 100 includes a communicator 110, a storage 120, a controller 130, and a power supply source 140. The controller 130 controls power generation using the power supply source 140. In the present embodiment, the power supplier system 100 is constructed in a server.

The power supply source 140 may include power generation equipment. The power generation equipment may include a power generation apparatus that generates power using renewable energy or may include a power generation apparatus that generates power using fossil fuels. The power generation equipment includes, for example, at least one selected from the group consisting of a thermal power generation apparatus, a nuclear power generation apparatus, a hydraulic power generation apparatus, a photovoltaic power generation apparatus, a solar thermal power generation apparatus, a wind power generation apparatus, a geothermal power generation apparatus, a biomass power generation apparatus, a tidal power generation apparatus, and an ocean thermal energy conversion power generation apparatus. The power supply source 140 may also include an electric facility for power transmission or distribution. The electric facility for power transmission or distribution may be used as equipment for receiving power supplied from another power supplier, but can also be used as equipment for supplying power to other equipment. When the power supply source 140 is an electric facility for power transmission or distribution, the controller 130 may be a system that controls supply of power via the electric facility for power transmission or distribution. The power supplier system 100 may use equipment for another operator under a contract and supply power to a power consumer 270 using equipment including the equipment for the other operator.

### Power Consumer System 200

The power consumer system 200 is a system for the power consumer 270. The power consumer 270 may be a natural person or may be a juridical person.

The power consumer system 200 includes a communicator 210, a storage 220, a controller 230, and a load 240. In the present embodiment, the power consumer system 200 can communicate with external systems via the network 20.

The load 240 is provided for a power demand entity. The power demand entity is, for example, a factory. The load 240 includes at least one demand device and/or at least one demand facility. The demand device is, for example, a motor or an air conditioner. The demand facility is, for example, a charging facility for electric vehicles (EVs), automated guided vehicles (AGVs), or the like.

### Power Information Management System 300

The power information management system 300 includes a communicator 310, a storage 320, and a controller 330. In the present embodiment, the power information management system 300 is constructed in a server.

### EMS 400

The EMS 400 includes a communicator 410, a storage 420, a controller 430, a display 440, and a speaker 450. In the present embodiment, the communicator 410, the storage 420, and the controller 430 can communicate with the power consumer system 200 via the network 20.

The EMS 400 has a function of operating the load 240 in a normal mode. The EMS 400 also has a function of operating the load 240 in an energy-saving mode. In the energy-saving mode, power consumption of the load 240 is suppressed compared to in the normal mode.

The EMS 400 has a function of suppressing a peak of the load 240. This function suppresses a peak of the power consumption of the load 240 using the controller 430.

The EMS 400 has a function of controlling a demand. This function adjusts (usually suppresses) a demand value to a specified value and/or issues a warning in a given case. The given case is, for example, a case where the demand value exceeds a given value.

The EMS 400 has a function of setting an upper limit value of the power consumption of the load 240. When the upper limit value is set, the controller 430 limits the power consumption of the load 240 to the upper limit value or smaller and issues a warning of necessity of the limitation.

The EMS 400 has a function of displaying a warning relating to the load 240. This function causes, using the controller 430, the display 440 to display a warning when the power consumption of the load 240 is out of a specified range.

The EMS 400 has a function of outputting a warning sound relating to the load 240. This function causes, using the controller 430, the speaker 450 to output a warning sound when it is detected that the power consumption of the load 240 is out of the specified range.

With respect to the function of displaying a warning and the function of outputting a warning sound, a case where “the power consumption is out of the specified range” is not particularly limited. “The power consumption is out of the specified range” refers to, for example, a case where the power consumption is larger than or equal to a predetermined threshold, a case where the power consumption is smaller than a predetermined threshold, a case where the power consumption is out of a predetermined range, or the like. When “the power consumption is out of the specified range” refers to the case where the power consumption is larger than or equal to a predetermined threshold, the predetermined threshold may be an upper limit value of the power consumption of the load 240, contract demand, or the like. A specified target for a warning is not limited to power. For example, the specified target may be a current, a voltage, a temperature, or the like measured or monitored by a function of an apparatus included in the EMS 400 or by an individual EMS. A method for presenting a warning to a user is not particularly limited. For example, a measured value out of the specified range or information regarding an operation state may be recorded as an abnormal value or warning information.

The function of displaying a warning and the function of outputting a warning sound are activated when, for example, the power consumption of the load 240 exceeds a predetermined value. Typically, the predetermined value is larger than the upper limit value of the power consumption.

### Verification System 500

The verification system 500 includes a communicator 510, a storage 520, and a controller 530. In the present embodiment, the verification system 500 is constructed in a server.

In the present embodiment, it is desirable that the verification system 500 be a third-party system and be in a neutral position with respect to the power supplier system 100 and the power consumer system 200. The verification system 500 may belong to a public institution.

### Contract System 600

The contract system 600 includes a communicator 610, a storage 620, and a controller 630. In the present embodiment, the contract system 600 is constructed in a server.

In the present embodiment, it is desirable that the contract system 600 be a third-party system and be in a neutral position with respect to the power supplier system 100 and the power consumer system 200. The contract system 600 may belong to a public institution.

### DR Issuing System 700

The DR issuing system 700 is for a DR issuer 770. The DR issuer 770 may be a natural person or may be a juridical person.

The DR issuing system 700 includes a communicator 710, a storage 720, and a controller 730. In the present embodiment, the DR issuing system 700 is constructed in a server.

The controller 730 can cause the communicator 710 to transmit a DR command. The DR command is a command for a DR. Details of a DR and a DR command will be described later.

The communicators 110, 210, 310, 410, 510, 610, and 710 are connected to each other via the network 20 and communicate with each other via the network 20.

In the example illustrated in FIG. 1, the network 20 includes, for example, the Internet. The network 20 may include one or a plurality of local area networks (LANs). Alternatively, the network 20 may be a combination of the Internet and one or a plurality of LANs.

### Environment of Infrastructure 10

### Actual-Demand Contract

An actual-demand contract is concluded between the power supplier 170 and the power consumer 270. In the actual-demand contract, larger contract demand is set between the power supplier 170 and the power consumer 270 as a maximum demand value of the power consumer 270 increases. The maximum demand value is a maximum value of a demand value in the most recent period. The demand value is average power consumed in each unit period. The contract demand is determined on the basis of the maximum demand value. In a typical example, the most recent period is 12 months including a current month. The unit period is 30 minutes.

If a demand value of even one unit period exceeds a maximum demand value in the most recent period, the maximum demand value is updated, and larger contract demand is set. When the larger contract demand is set, a higher electricity charge is imposed for a specified period beginning with the time of the setting. In a typical example, the specified period is 12 months.

The actual-demand contract is, for example, a mode of a high-voltage power contract. The high-voltage power contract is, for example, a contract in which a standard voltage is 6,000 V.

It is beneficial for the power consumer 270 to suppress the electricity charge. The EMS 400, therefore, is configured to suppress an increase in the demand value in each unit period.

### DR

A DR makes it possible to balance supply and demand of power. The DR can be an upward DR or a downward DR. The upward DR is issued to increase the demand of power. The downward DR is issued to reduce the demand of power.

As described above, the DR issuing system 700 can transmit a command for a DR, that is, a DR command. The DR command can be an upward DR command or a downward DR command. The upward DR command is a command for an upward DR. The downward DR command is a command of a downward DR.

The DR command indicates the amount of change in the amount of power consumption in a predetermined period. The upward DR command indicates the amount of increase in the amount of power consumption in the predetermined period. The downward DR command indicates the amount of decrease in the amount of power consumption in the predetermined period.

For example, the DR issuer 770 is a transmission and distribution operator. For example, the DR issuing system 700 receives a request to issue a DR command from a requester. The requester is, for example, the power supplier system 100. It is beneficial for the transmission and distribution operator to stabilize the power system using DR commands.

In the present embodiment, the power information management system 300 receives an upward DR command. The power consumer system 200 can operate in accordance with the upward DR command.

### Example of Operation of Each Component of Infrastructure 10

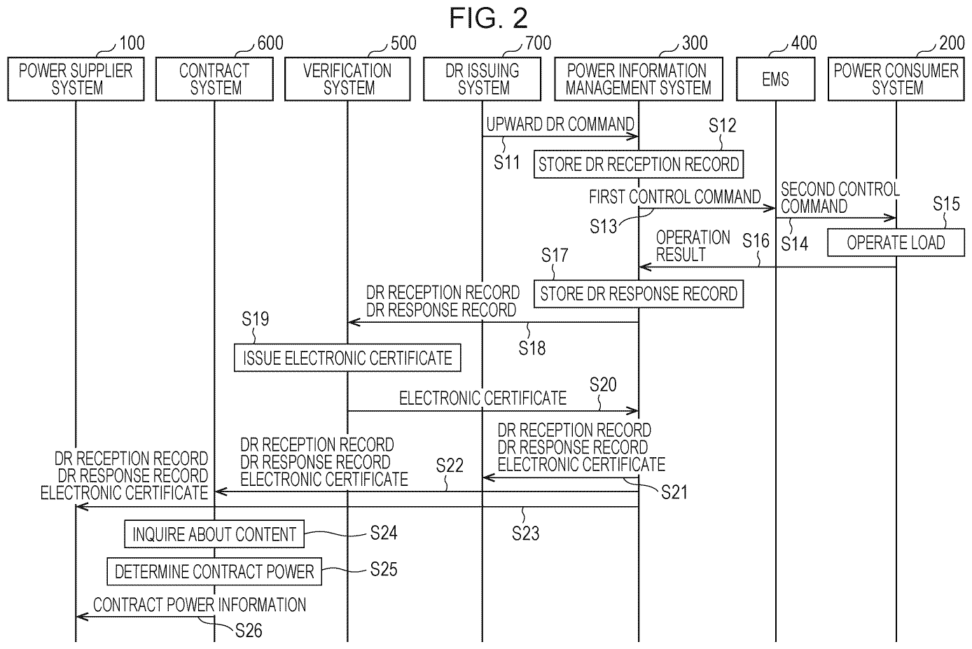

FIG. 2 is a sequence diagram illustrating an example of a scenario that can occur in the infrastructure 10. Operation of each component of the infrastructure 10 will be described hereinafter with reference to FIG. 2.

In step S11, the controller 730 of the DR issuing system 700 causes the communicator 710 to transmit an upward DR command to the communicator 310 of the power information management system 300 via the network 20. The upward DR command for the power information management system 300 indicates that the amount of power consumption of the load 240 is to be increased in a predetermined period.

Next, in step S12, the controller 330 of the power information management system 300 generates a DR reception record on the basis of the upward DR command. The controller 330 then stores the DR reception record in the storage 320. In the present embodiment, a DR reception record includes:
(p) an upward DR command;
(q) information indicating content of the upward DR command; and
(r) information indicating a time at which the upward DR command has been received.

The information (q) is, for example, information indicating a period of an upward DR and the amount of increase in the amount of power consumption based on the upward DR.

In the present embodiment, information indicating that an upward DR command has been received includes the command (p), the information (q), and the information (r).

The DR reception record may or may not include the information (q). The information indicating that an upward DR command has been received may or may not include the information (q). The DR reception record includes at least the command (p) and the information (r). The information indicating that an upward DR command has been received includes at least the command (p) and the information (r).

Next, in step S13, the controller 330 of the power information management system 300 reads the upward DR command in the DR reception record from the storage 320 and generates a first control command reflecting the upward DR command. The controller 330 then causes the communicator 310 to transmit the first control command to the communicator 410 of the EMS 400 via the network 20. The first control command is stored in the storage 420.

Next, in step S14, the controller 430 of the EMS 400 generates a second control command reflecting the first control command. The controller 430 then causes the communicator 410 to transmit the second control command to the communicator 210 of the power consumer system 200 via the network 20. The second control command is stored in the storage 220.

Next, in step S15, the controller 230 of the power consumer system 200 operates the load 240 on the basis of the second control command. The amount of power consumption of the load 240 is thus increased on the basis of the upward DR command.

The second control command can bring about, for example, at least one selected from the group consisting of:
deactivation of the function of suppressing a peak of the load 240;
upward correction of a demand control value of the load 240;
deactivation of the energy-saving mode of the load 240;
suppression or deactivation of the function of displaying a warning relating to the load 240;
suppression or deactivation of the function of outputting a warning sound relating to the load 240;
causing, using the controller 430, the display 440 to display information indicating that the load 240 is operating on the basis of an upward DR command; and
causing, using the controller 430, the speaker 450 to output a sound indicating that the load 240 is operating on the basis of an upward DR command.

In the present embodiment, the demand control value of the load 240 is the upper limit value of the power consumption of the load 240. The demand control value is managed by the EMS 400. Specifically, a function of a demand controller or the like in the EMS 400 performs the management.

In the present embodiment, the controller 230 of the power consumer system 200 stores, in the storage 220, a time at which the operation of the load 240 based on the upward DR command has started and a time at which the operation of the load 240 based on the upward DR command has ended.

Next, in step S16, the controller 230 of the power consumer system 200 causes the communicator 210 to transmit an operation result of the load 240 to the communicator 310 of the power information management system 300 via the network 20. The operation result is stored in the storage 320.

The power information management system 300 can recognize a relationship between the upward DR command and the operation of the load 240 on the basis of the DR reception record and the operation result. The relationship includes the increase in the amount of power consumption of the load 240 based on the upward DR command.

Next, in step S17, the controller 330 of the power information management system 300 generates a DR response record. The controller 330 then stores the DR response record in the storage 320. In the present embodiment, a DR response record includes:
(a) information indicating an entity that has responded to an upward DR command;
   (b) information indicating a source of the upward DR command;
   (c) information indicating a period in which the upward DR command has been responded to;
(d) information indicating that power consumption of the entity in (a) has exceeded contract demand as a result of the response to the upward DR command;
(e) information indicating a demand value increased in accordance with an upward DR; and
(f) information indicating a maximum demand value in the period in which the upward DR has been responded to.

The information (a) includes, for example, an identifier (ID) of the entity that has responded to the upward DR command. The information (a) may include information indicating which device in the entity that has responded to the upward DR command has been controlled because of the upward DR command. In the present embodiment, the information (c) includes a start time at which the response to the upward DR command has started and an end time at which the response to the upward DR command has ended.

The information (e) may be information indicating a temporal change in the power consumption of the entity in (a) in the period in which the upward DR has been responded to, may be information indicating the amount of power consumption of the entity in (a) in each unit period in the period in which the upward DR has been responded to, or may be information indicating the total amount of power consumption of the entity in (a) in the period in which the upward DR has been responded to. As described above, the unit period is, for example, 30 minutes.

In an example, the DR command includes a command to the power consumer system 200 for achieving an increase in the amount of power consumption of a total of [Y] kWh in [X] hours. In this example, the power consumer system 200 can determine how to distribute the increase in the amount of power consumption to each unit period. In this example, the information (e) may be information indicating a temporal change in power consumption of the power consumer system 200 in [X] hours, may be information indicating the amount of power consumption of the power consumer system 200 in each unit period in [X] hours, or may be the total amount of power consumption of the power consumer system 200 in [X] hours.

In a first example of the present embodiment, information indicating that the upward DR command has been responded to includes the information (a), the information (b) and the information (c).

A DR response record in the first example may or may not include the information (d), may or may not include the information (e), and may or may not include the information (f). The DR response record includes at least the information (a), the information (b), and the information (c).

In the present embodiment, the entity in (a) is the power consumer 270. The entity in (a) can also be regarded as the power consumer system 200, or more specifically, the load 240.

In the present embodiment, the source in (b) is the DR issuer 770. The source in (b) can also be regarded as the DR issuing system 700. The DR response record may include information indicating the requester of the DR command along with, or instead of, the source in (b).

Next, in step S18, the controller 330 of the power information management system 300 causes the communicator 310 to transmit the DR reception record and the DR response record to the communicator 510 of the verification system 500 via the network 20. The DR reception record and the DR response record are stored in the storage 520.

Next, in step S19, the controller 530 of the verification system 500 issues an electronic certificate relating to the DR reception record and the DR response record. The electronic certificate indicates that the verification system 500 has received the DR reception record and the DR response record. By issuing the electronic certificate, authenticity of the DR reception record and the DR response record is verified. The electronic certificate accompanies, for example, time information regarding the reception of the DR reception record and time information regarding the reception of the DR response record.

Next, in step S20, the controller 530 of the verification system 500 causes the communicator 510 to transmit the electronic certificate to the communicator 310 of the power information management system 300 via the network 20. The electronic certificate is stored in the storage 320.

Next, in step S21, the controller 330 of the power information management system 300 causes the communicator 310 to transmit the DR reception record, the DR response record, and the electronic certificate to the communicator 710 of the DR issuing system 700 via the network 20. The DR reception record, the DR response record, and the electronic certificate are stored in the storage 720.

Next, in step S22, the controller 330 of the power information management system 300 causes the communicator 310 to transmit the DR reception record, the DR response record, and the electronic certificate to the communicator 610 of the contract system 600 via the network 20. The DR reception record, the DR response record, and the electronic certificate are stored in the storage 620.

Next, in step S23, the controller 330 of the power information management system 300 causes the communicator 310 to transmit the DR reception record, the DR response record, and the electronic certificate to the communicator 110 of the power supplier system 100 via the network 20. The DR reception record, the DR response record, and the electronic certificate are stored in the storage 120.

Next, in step S24, the controller 630 of the contract system 600 inquires of the verification system 500 about content of the DR reception record, the DR response record, and the electronic certificate. As an example, the contract system 600 transmits the electronic certificate to the verification system 500, and the verification system 500 verifies authenticity of the electronic certificate and transmits a result of the verification to the contract system 600.

Authenticity of information may be verified by a method different from that used in step S24. As an example, the contract system 600 checks verification content of the electronic certificate using a certificate of the verification system 500 obtained in advance. In addition, as an example, the contract system 600 confirms, using signature information of the electronic certificate, that the content of the DR reception record and the DR response record has not been altered. In addition, as an example, the contract system 600 verifies the authenticity of the content of the DR reception record and the DR response record by comparing the content with unalterable ledger data provided by the verification system 500.

Next, in step S25, the controller 630 of the contract system 600 determines contract demand between the power supplier 170 and the power consumer 270.

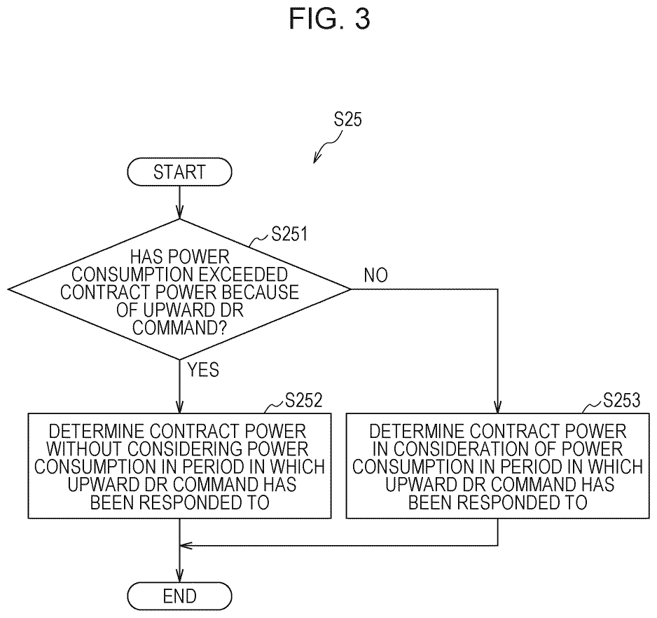

FIG. 3 is a flowchart illustrating the determination of the contract demand in step S25.

In step S251, the controller 630 determines whether the power consumption of the entity in (a) has exceeded the contract demand because of an upward DR command. If so, the process proceeds to step S252. If not, the process proceeds to step S253.

Specifically, in step S251, the controller 630 reads the DR response record from the storage 620. The controller 630 then determines whether, on the basis of the information (d) included in the DR response record, whether the power consumption has exceeded the contract demand because of an upward DR command.

In step S252, the controller 630 determines the contract demand without taking into consideration the power consumption in the period in (c). In step S253, on the other hand, the controller 630 determines the contract demand in consideration of the power consumption in the period in (c). The “determination” in steps S252 and S253 is specifically “update”.

In the present embodiment, in steps S252 and S253, the controller 630 generates contract demand information. The contract demand information indicates contract demand. The contract demand information is stored in the storage 620.

After step S25, in step S26, the controller 630 of the contract system 600 causes the communicator 610 to transmit the contract demand information to the communicator 110 of the power supplier system 100 via the network 20.

### Techniques Applicable to Embodiment

Techniques applicable to the above-described embodiment will be described hereinafter.

The load 240 may be a household load. In this case, at least one demand device in a household consumes power. The demand device is, for example, a household electrical appliance. The household electrical appliance is, for example, a television set or a refrigerator.

The DR issuing system 700 and the power information management system 300 may negotiate with each other. For example, the content of the upward DR command is updated through the negotiation.

In an example, first, the DR issuing system 700 transmits a first upward DR command to the power information management system 300. Next, the power information management system 300 transmits a request to correct the first upward DR command to the DR issuing system 700. Next, the DR issuing system 700 transmits a second upward DR command to the power information management system 300. The second upward DR command is obtained by correcting the first upward DR command on the basis of the correction request. The second upward DR command in this example can be considered as the upward DR command in step S11 in FIG. 2.

In a specific example, the first upward DR command includes information indicating that the demand value of the power consumer 270 is to be increased by 100 kWh. The correction request includes a request to reduce the amount of increase in the demand value from 100 kWh to 90 kWh. The second upward DR command includes information indicating that the demand value of the power consumer 270 is to be increased by 90 kWh. As described above, the demand value is, for example, average power consumed in 30 minutes.

For example, the DR response record generated and stored in step S17 in FIG. 2 relates to the predetermined period of the upward DR command. For example, the DR response record generated and stored in step S17 in FIG. 2 relates to, in the predetermined period of the upward DR command, only a period in which the power consumption of the entity in (a) has exceeded the contract demand in accordance with the upward DR command.

The method for verifying the DR reception record and the DR response record described with reference to FIG. 2 is an example. The DR reception record and the DR response record may be verified by another known method such as known electronic certification. At this time, it is typically only required that the power information management system 300 be able to verify content of a command to a DR of the power consumer system 200 and a result relating to control of the load 240, and a verification procedure (timings and content of steps) may be different depending on an electronic verification method employed by the verification system 500. For example, when verification can be performed by registering verification content to the verification system 500, issuance of a certificate and transmission of DR records between the systems need not necessarily be performed, and an identifier necessary to refer to the registered content may be transmitted instead of, or in addition to, the issuance of a certificate and the transmission of DR records. When the power information management system 300 generates unalterable information (also called a “security token”) for verification content and then the verification system 500 verifies the security token, verification targets of the verification system 500 need not be DR records themselves.

In a typical example, the DR reception record, the DR response record, and the electronic certificate transmitted to the power supplier system 100 in step S23 in FIG. 2 are for record-keeping. Therefore, the DR reception record, the DR response record, and the electronic certificate need not necessarily be transmitted on the same day as the operation in step S15 is performed. The DR reception record, the DR response record, and the electronic certificate may be transmitted any day after the operation in step S15 is performed. The same holds for the DR reception record, the DR response record, and the electronic certificate transmitted to the DR issuing system 700 in step S21 in FIG. 2. Content may be recorded by using unalterable ledger data based on a blockchain technology or the like instead of transmitting a certificate itself. In this case, an identifier or the like indicating a particular record in a ledger may be transmitted instead of an electronic certificate.

The power information management system 300 may transmit the DR reception record, the DR response record, and the electronic certificate to the power supplier system 100 via the DR issuing system 700 or the like.

Verification may be performed in relation to step S21. For example, the DR issuing system 700 determines whether the content of the DR reception record and the DR response record received in step S21 is different from that of the DR command transmitted from the DR issuing system 700 to the power information management system 300 in step S11. If not, the controller 730 of the DR issuing system 700 obtains verification information indicating that there is no difference from the verification system 500 and transmits the verification information to the power information management system 300. The verification information indicating that there is no difference is then included in the electronic certificate transmitted from the power information management system 300 to the contract system 600 in step S22. According to this example, the contract system 600 can confirm more exactly that the DR command has been transmitted without inquiring of the DR issuing system 700.

Step S21 may be omitted. In this case, for example, the contract system 600 may inquire of the DR issuing system 700 whether an upward DR command whose content is not different from that of the DR reception record and the DR response record received by the contract system 600 has been actually transmitted to the power information management system 300 in step S22. According to this example, the contract system 600 can confirm more exactly that the DR command has been transmitted, and a processing load of the power information management system 300 relating to step S22 can be reduced.

The contract system 600 may transfer the DR reception record, the DR response record, and the electronic certificate received in step S22 to the power supplier system 100. In this case, step S23 can be omitted.

The power supplier system 100 may transfer the DR reception record, the DR response record, and the electronic certificate received in step S23 to the contract system 600. In this case, step S22 can be omitted.

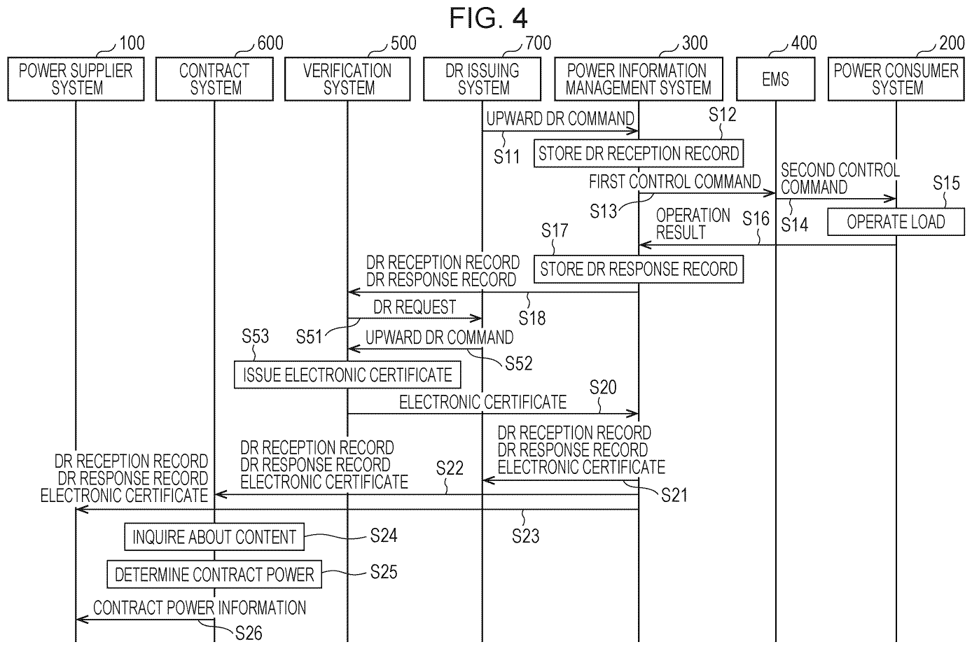

FIG. 4 is a sequence diagram illustrating a modification of the example of the scenario that can occur in the infrastructure 10.

In this modification, after step S18, in step S51, the controller 530 of the verification system 500 causes the communicator 510 to transmit a DR request to the communicator 710 of the DR issuing system 700 via the network 20. As described above, the verification system 500 has received the DR reception record including the upward DR command from the power information management system 300 in step S18. The DR request is a request to transmit, from the DR issuing system 700 to the verification system 500, the same upward DR command as the upward DR command transmitted to the power information management system 300. The DR request is stored in the storage 720.

Next, in step S52, the controller 730 of the DR issuing system 700 causes the communicator 710 to transmit the upward DR command to the communicator 510 of the verification system 500 via the network 20. The upward DR command is stored in the storage 520.

Next, in step S53, if it is determined that the DR reception record and the DR response record are authentic, the controller 530 of the verification system 500 issues an electronic certificate relating to the DR reception record and the DR response record. By issuing the electronic certificate, the authenticity of the DR reception record and the DR response record is verified.

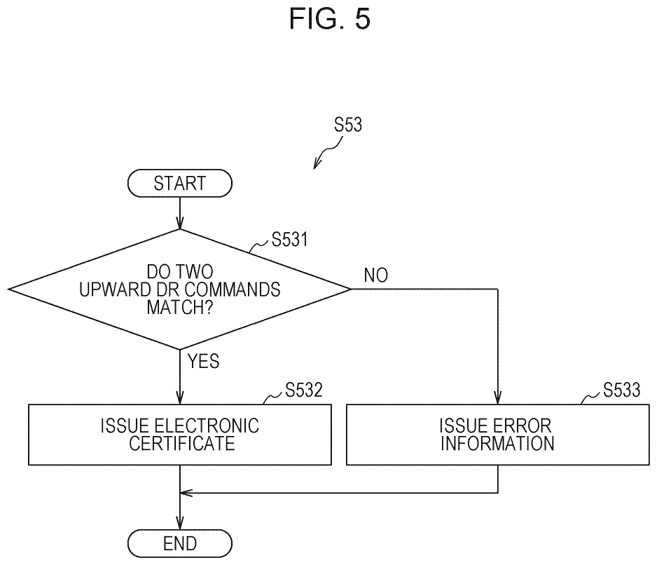

FIG. 5 is a flowchart illustrating the issuance of an electronic certificate in step S53.

In step S531, the controller 530 determines whether the two upward DR commands match. One of the two upward DR commands is the upward DR command included in the DR reception record. The other of the two upward DR commands is the upward DR command received by the verification system 500 from the DR issuing system 700 as a response to the DR request. If the two upward DR commands match, the process proceeds to step S532. If the two upward DR commands do not match, on the other hand, the process proceeds to step S533.

In step S532, the controller 530 issues an electronic certificate. By issuing a DR verification token, the authenticity of the DR reception record and the DR response record is verified. In step S533, on the other hand, the controller 530 issues error information.

As understood from the above description with reference to FIG. 5, in the present modification, if a result of step S531 is “YES”, it is determined that the DR reception record and the DR response record are authentic. If the result of step S531 is “NO”, on the other hand, it is determined that the DR reception record and the DR response record are not authentic. If the result of step S531 is “NO”, there is a suspicion that the DR reception record and the DR response record have been falsified by the power consumer 270 or someone else.

FIG. 4 illustrates an example of a scenario in which an electronic certificate is issued in step S53.

When the amount of power consumption of the power consumer 270 increases, an electricity charge to be paid by the power consumer 270 to the power supplier 170 can increase. If the electricity charge has increased because the power consumer 270 has responded to an upward DR command, the increased electricity charge may be compensated for. The compensation is achieved, for example, by a contractual offset arrangement.

The contractual offset arrangement is performed, for example, as follows. That is, the contract system 600 or the like concludes a contract (refund contract) for refunding, if the electricity charge has increased because of an upward DR command, an amount corresponding to the increase in the electricity charge from the power supplier 170 to the power consumer 270. The controller 130 of the power supplier system 100 determines the amount to be refund on the basis of the information (e) in the DR response record obtained in step S23 in FIG. 2. The determined amount is then refunded from the power supplier 170 to the power consumer 270 on the basis of the refund contract.

If a predetermined condition is satisfied as a result of an increase in the amount of power consumption of the power consumer 270, an electricity rate plan of the power consumer 270 can be changed or a penalty is imposed on the power consumer 270. If the predetermined condition is satisfied because the power consumer 270 has responded to an upward DR command, the electricity rate plan may remain the same or a penalty may be prevented from being imposed.

A mechanism may be employed in which a reward is given to the power consumer 270 when the power consumer 270 responds to an upward DR command.

The reward is given to the power consumer 270, for example, as follows. That is, the controller 730 of the DR issuing system 700 determines the reward to be given to the power consumer 270 on the basis of the information (e) in the DR response record obtained in step S21 in FIG. 2. The determined reward is then given to the power consumer 270.

The reward is, for example, money, points, a price discount, or the like. In an example, a source of the reward is covered by the DR issuing system 700. In another example, the source of the reward is covered by a requester who has requested issuance of the upward DR from the DR issuing system 700. In this example, it is possible that the requester pays a reward to the DR issuing system 700 as an intermediary fee.

In the embodiment described above, the power consumer 270 leaves a record indicating that the power consumer 270 under an actual-demand contract with the power supplier 170 has responded to a request to increase the amount of power consumption of the power consumer 270 in a predetermined period without knowing whether the power consumption has exceeded the contract demand. Specifically, the power consumer 270 leaves such a record in preparation for a case where the power consumption of the power consumer 270 has exceeded the contract demand. The power consumer 270, however, may leave a record indicating that the power consumer 270 under an actual-demand contract with the power supplier 170 has responded to a request to increase the amount of power consumption of the power consumer 270 in a predetermined period knowing whether the power consumption has exceeded the contract demand.

In the example illustrated in FIG. 1, the verification system 500 and the power supplier system 100 are different systems. The verification system 500, however, may be included in the power supplier system 100, instead.

In the example illustrated in FIG. 1, the contract system 600 and the power supplier system 100 are different systems. The contract system 600, however, may be included in the power supplier system 100, instead.

In the example illustrated in FIG. 1, the DR issuing system 700 and the power supplier system 100 are different systems. The DR issuing system 700, however, may be included in the power supplier system 100, instead.

In the example illustrated in FIG. 1, the verification system 500 and the DR issuing system 700 are different systems. The verification system 500, however, may be included in the DR issuing system 700, instead.

In the example illustrated in FIG. 1, the contract system 600 and the DR issuing system 700 are different systems. The contract system 600, however, may be included in the DR issuing system 700, instead.

In the example illustrated in FIG. 1, the verification system 500 and the contract system 600 are different systems. The verification system 500, however, may be included in the contract system 600, instead.

In the example illustrated in FIG. 1, the EMS 400 and the power consumer system 200 are different systems. The EMS 400, however, may be included in the power consumer system 200, instead.

In the example illustrated in FIG. 1, the power information management system 300 and the power consumer system 200 are different systems. The power information management system 300, however, may be included in the power consumer system 200, instead.

In the example illustrated in FIG. 1, the power information management system 300 and the EMS 400 are different systems. The power information management system 300, however, may be included in the EMS 400, instead.

In the example illustrated in FIG. 1, the verification system 500 and the DERMS 30 are different systems. The verification system 500, however, may be included in the DERMS 30, instead.

In the example illustrated in FIG. 1, the contract system 600 and the DERMS 30 are different systems. The contract system 600, however, may be included in the DERMS 30, instead.

In the example illustrated in FIG. 1, the DR issuing system 700 and the DERMS 30 are different systems. The DR issuing system 700, however, may be included in the DERMS 30, instead.

### Method and System Understood from Above Description

As can be understood from the above description, the present disclosure discloses a power information management method. Specifically, the power information management method is performed by the power information management system 300.

In an example, the power information management method includes first and second steps. In the first step, a record indicating that the power consumer 270 under an actual-demand contract with the power supplier 170 has responded to a request to increase the amount of power consumption in a predetermined period is kept. In the second step, the record is transmitted to the power supplier 170. This configuration makes it possible to take a reasonable measure when the power consumer 270 under the actual-demand contract increases the amount of power consumption on the basis of a request to increase the amount of power consumption.

The reasonable measure will be described. For example, the reasonable measure can correspond to the determination of contract demand without taking into consideration power consumption in the period in which the upward DR command has been responded to in step S252 in FIG. 3. In addition, for example, the reasonable measure can correspond to allowing the electricity rate plan to remain the same or preventing a penalty from being imposed if the predetermined condition is satisfied because the power consumer 270 has responded to an upward DR command. In addition, for example, the reasonable measure can correspond to giving a reward to the power consumer 270 when the power consumer 270 responds to an upward DR command.

In this configuration, the “request” can be the upward DR command described with reference to FIG. 2 and the like.

In a first example of this configuration, “a record indicating that the power consumer 270 under an actual-demand contract with the power supplier 170 has responded to a request” refers to the DR response record described with reference to FIG. 2 and the like. Specifically, the DR response record is a record directly indicating that the request has been responded to. “A record indicating that the power consumer 270 under an actual-demand contract with the power supplier 170 has responded to a request to increase the amount of power consumption in a predetermined period is kept” refers to, for example, step S17, where the storage 320 stores the DR response record.

In a second example of this configuration, “a record indicating that the power consumer 270 under an actual-demand contract with the power supplier 170 has responded to a request” refers to the DR reception record described with reference to FIG. 2 and the like. Specifically, the DR reception record is a record indirectly indicating that the request has been responded to. “A record indicating that the power consumer 270 under an actual-demand contract with the power supplier 170 has responded to a request to increase the amount of power consumption in a predetermined period is kept” refers to, for example, step S12, where the storage 320 stores the DR reception record.

In the second example, a destination of the DR reception record refers to an actual value of the power consumption of the power consumer 270. As a result of the reference, the destination can confirm, on the basis of the actual value of the power consumption, whether the power consumer 270 has responded to the request to increase the amount of power consumption in the predetermined period. The destination is, for example, the power supplier system 100. The actual value is, for example, metering data. In the first example, the destination of the DR reception record may refer to the actual value of the power consumption of the power consumer 270.

In this configuration, the transmission to the power supplier 170 in the second step may be transmission to the power supplier 170 via a relay element such as the DR issuer 770. The transmission to the power supplier 170 in the second step may be transmission to the power supplier 170 without using a relay element.

“A record indicating that the power consumer 270 under an actual-demand contract with the power supplier 170 has responded to a request to increase the amount of power consumption in a predetermined period is kept” in this configuration will be described. The record may be kept without the power consumer 270 knowing whether the power consumption thereof has exceeded the contract demand. The record may be kept with the power consumer 270 knowing whether the power consumption of the power consumer 270 has exceeded the contract demand.

In an example, the record is kept when the power consumption of the power consumer 270 exceeds the contract demand in response to a request. This configuration makes it possible to take a reasonable measure relating to a period in which the power consumption of the power consumer 270 has exceeded the contract demand in accordance with a request.

The expression “the record is kept when the power consumption of the power consumer 270 exceeds the contract demand in response to the request” will be described. This expression means that it is only required that the record be kept when the power consumption of the power consumer 270 exceeds the contract demand in response to the request, and whether to keep the record at other timings may be arbitrarily determined. For example, the record may be kept not only when the power consumption of the power consumer 270 exceeds the contract demand in response to the request but also when the power consumption of the power consumer 270 does not exceed the contract demand in response to the request. Alternatively, the record may be kept only when the power consumption of the power consumer 270 exceeds the contract demand in response to the request.

In this configuration, “the power consumption of the power consumer 270” can be the power consumption of the power consumer system 200. Specifically, “the power consumption of the power consumer 270” can be the power consumption of the load 240.

In an example, the record includes information indicating that the power consumption of the power consumer 270 has exceeded the contract demand in response to the request. This configuration makes it possible to take the reasonable measure relating to the contract demand.

In an example, the record includes information indicating a period in which the power consumption of the power consumer 270 has exceeded the contract demand in response to the request.

In an example, the record is a verified record. With this configuration, reliability can be ensured since it can be confirmed the record is authentic and not falsified by the power consumer 270 or the like.

In this configuration, “a verified record” is, for example, a record with a certificate. For example, the certificate corresponds to the “electronic certificate” in step S23 in FIG. 2. The record corresponds to the “DR response record” in step S23 in FIG. 2.

With respect to “a verified record” in this configuration, the record may be verified before or after the power consumer 270 responds to the request to increase the amount of power consumption. In the first example, where “a record that the power consumer 270 under an actual-demand contract with the power supplier 170 has responded to a request” is the DR response record, for example, the record is verified after the request is responded to. In the second example, where “a record that the power consumer 270 under an actual-demand contract with the power supplier 170 has responded to a request” is the DR reception record, on the other hand, the record may be verified before or after the request is responded to.

As can be understood from the above description, the present disclosure discloses the power information management system 300 of the power consumer 270 under an actual-demand contract with the power supplier 170.

Here, the expression “the power information management system 300 of the power consumer 270” will be described. This expression intends that the power information management system 300 manages power information regarding the power consumer 270. This expression is intended to include a mode in which the power consumer system 200 and the power information management system 300 are different systems and a mode in which the power consumer system 200 includes the power information management system 300.

In an example, the power information management system 300 includes the communicator 310, the storage 320, and the controller 330. The storage 320 keeps a record indicating that the power consumer 270 has responded to a request to increase the amount of power consumption in a predetermined period. When the power consumer 270 responds to the request, the controller 330 causes the storage 320 to store the record and causes the communicator 310 to transmit the record to the power supplier 170.

As can be understood from the above description, the present disclosure discloses a contract method. Specifically, the contract method is performed by the contract system 600.

In an example, the contract method includes third and fourth steps. In the third step, a record indicating that a request to increase the amount of power consumption has been responded to in a predetermined period is received from the power consumer 270 under an actual-demand contract with the power supplier 170. In the fourth step, if it is determined on the basis of the record that the power consumption of the power consumer 270 has exceeded contract demand because the request has been responded to, the contract demand for the power consumer 270 is determined without taking into consideration the power consumption of the power consumer 270 exceeding the contract demand.

As can be understood from the above description, the present disclosure discloses the contract system 600.

In an example, the contract system 600 includes the communicator 610 and the controller 630. The communicator 610 receives, from the power consumer 270 under an actual-demand contract, a record indicating that a request to increase the amount of power consumption has been responded to in a predetermined period. If it is determined on the basis of the record that the power consumption of the power consumer 270 has exceeded the contract demand because the request has been responded to, the controller 630 determines the contract demand for the power consumer 270 without taking into consideration the power consumption of the power consumer 270 exceeding the contract demand.

As can be understood from the above description, the present disclosure discloses a verification method. Specifically, the verification method is performed by the verification system 500.

In an example, the verification method includes fifth and sixth steps. In the fifth step, a record indicating that the power consumer 270 under an actual-demand contract has responded to a request to increase the amount of power consumption in a predetermined period is received. In the sixth method, the record is verified.

With respect to “the record is verified” in this configuration, the record may be verified before or after the power consumer 270 responds to the request to increase the amount of power consumption. For example, in the first example, where “a record that the power consumer 270 under an actual-demand contract with the power supplier 170 has responded to a request” is the DR response record, the record is verified after the request is responded to. In the second example, where “a record that the power consumer 270 under an actual-demand contract with the power supplier 170 has responded to a request” is the DR reception record, on the other hand, the record may be verified before or after the request is responded to.

As can be understood from the above description, the present disclosure discloses the verification system 500.

In an example, the verification system 500 includes the communicator 510 and the controller 530.

In an example, the communicator 510 receives a record indicating that the power consumer 270 under an actual-demand contract has responded to a request to increase the amount of power consumption in a predetermined period. The controller 530 verifies the record.

### APPENDIX

The above description of an embodiment discloses the following techniques.

### Technique 1

A power information management method including:
keeping a record indicating that a power consumer under an actual-demand contract with a power supplier has responded to a request to increase an amount of power consumption in a predetermined period; and
transmitting the record to the power supplier.

### Technique 2

The power information management method according to technique 1,
in which the record is kept when the power consumption of the power consumer exceeds contract demand in response to the request.

### Technique 3

The power information management method according to technique 1 or 2,
in which the record includes information indicating that the power consumption of the power consumer has exceeded contract demand in response to the request.

### Technique 4

The power information management method according to any of techniques 1 to 3,
in which the record is a verified record.

### Technique 5

A power information management system for a power consumer under an actual-demand contract with a power supplier, the power information management system including:
a communicator;
a storage that keeps a record indicating that the power consumer has responded to a request to increase an amount of power consumption in a predetermined period; and
a controller,
in which, when the power consumer responds to the request, the controller causes the storage to keep the record and causes the communicator to transmit the record to the power supplier.

### Technique 6

A contract method including:
receiving, from a power consumer under an actual-demand contract, a record indicating that a request to increase an amount of power consumption has been responded to in a predetermined period; and
determining, if it is determined on a basis of the record that the power consumption of the power consumer has exceeded contract demand because the request has been responded to, the contract demand for the power consumer without taking into consideration the power consumption of the power consumer exceeding the contract demand.

### Technique 7

A contract system including:
a communicator that receives, from a power consumer under an actual-demand contract, a record indicating that a request to increase an amount of power consumption has been responded to in a predetermined period; and
a controller that determines, if it is determined on a basis of the record that the power consumption of the power consumer has exceeded contract demand because the request has been responded to, the contract demand for the power consumer without taking into consideration the power consumption of the power consumer exceeding the contract demand.

### Technique 8

A verification method including:
receiving a record indicating that a power consumer under an actual-demand contract has responded to a request to increase an amount of power consumption in a predetermined period; and
verifying the record.

### Technique 9

A verification system including:
a communicator that receives a record indicating that a power consumer under an actual-demand contract has responded to a request to increase an amount of power consumption in a predetermined period; and
a controller that verifies the record.

With the techniques according to the present disclosure, it is possible to generate and verify a record regarding a response to an upward DR, leave an operational ground and evidence relating to an increase in power consumption for relevant systems, and make the record available for use in performance of a contract or the like.

What is claimed is:

1. A power information management method comprising:
keeping a record indicating that a power consumer under an actual-demand contract with a power supplier has responded to a request to increase an amount of power consumption in a predetermined period; and
transmitting the record to the power supplier.

2. The power information management method according to claim 1,
wherein the record is kept when the power consumption of the power consumer exceeds contract demand in response to the request.

3. The power information management method according to claim 1,
wherein the record includes information indicating that the power consumption of the power consumer has exceeded contract demand in response to the request.

4. The power information management method according to claim 1,
wherein the record is a verified record.

5. A power information management system for a power consumer under an actual-demand contract with a power supplier, the power information management system comprising:
a communicator;
a storage that keeps a record indicating that the power consumer has responded to a request to increase an amount of power consumption in a predetermined period; and
a controller,
wherein, when the power consumer responds to the request, the controller causes the storage to keep the record and causes the communicator to transmit the record to the power supplier.

6. A contract method comprising:
receiving, from a power consumer under an actual-demand contract, a record indicating that a request to increase an amount of power consumption has been responded to in a predetermined period; and
determining, if it is determined on a basis of the record that the power consumption of the power consumer has exceeded contract demand because the request has been responded to, the contract demand for the power consumer without taking into consideration the power consumption of the power consumer exceeding the contract demand.

7. A contract system comprising:
a communicator that receives, from a power consumer under an actual-demand contract, a record indicating that a request to increase an amount of power consumption has been responded to in a predetermined period; and
a controller that determines, if it is determined on a basis of the record that the power consumption of the power consumer has exceeded contract demand because the request has been responded to, the contract demand for the power consumer without taking into consideration the power consumption of the power consumer exceeding the contract demand.

8. A verification method comprising:
receiving a record indicating that a power consumer under an actual-demand contract has responded to a request to increase an amount of power consumption in a predetermined period; and
verifying the record.

9. A verification system comprising:
a communicator that receives a record indicating that a power consumer under an actual-demand contract has responded to a request to increase an amount of power consumption in a predetermined period; and
a controller that verifies the record.
